(19) United States
(12) Patent Application Publication
(10) Pub. No.: US 2010/0285896 A1
(43) Pub. Date: Nov. 11, 2010

(54) Golf grip with holding control arrangement

(76) Inventor: Yung-Hsiang Chen, Walnut, CA (US)

Correspondence Address: DAVID AND RAYMOND PATENT FIRM, 108 N. YNEZ AVE., SUITE 128, MONTEREY PARK, CA, 91754, US

(21) Appl. No.: 12/387,919

(22) Filed: May 8, 2009

(51) Int. Cl. A63B 53/14; B29C 63/06

(52) U.S. Cl. 473/300; 156/188

(57) ABSTRACT

A golf grip includes a grip member and a holding control arrangement provided on an outer circumferential surface of the golf grip. The holding control arrangement has a first controlling surface and a second controlling surface having different frictional coefficients and longitudinally extended along a longitudinal axis direction of a shaft of a golf club, so that the two different textures adjacent between the first and second controlling surfaces provides a force for resisting an unwanted twisting force. The unwanted twisting force is a force occurred at a tangent direction of the longitudinal shaft while the golf club is being swung. With the longitudinal first and second controlling surfaces of the holding control arrangement, the golf grip is capable of preventing the golf club rotatably slipping out the hand of the golfer and the unwanted twisting force.

### BACKGROUND OF THE PRESENT INVENTION

1. Field of Invention

The present invention relates to a golf club, and more particularly to a golf grip, wherein the golf grip has a holding control arrangement provided for a relatively better control of the golf club and more stable performance of playing golf.

2. Description of Related Arts

Golf club generally comprises a club head, a shaft extended from the club head, and a golf grip coupling with the shaft at the opposite end of the club head, wherein the holding golf grip is provided for the golfer having a relatively better controlling of the golf club and preventing the golf club slipping out the golfer's hands.

For the better performances of playing golf, stably controlling the golf club is one of the primary factors. In order to provide the stable controlling of the golf club for the golfer, increasing the frictions of the golf grip is commonly applied on most of the golf grip to significantly avoid the unwanted movement. For instance, normally the golf grip is made of a material having a relatively higher frictional coefficient, i.e. rubbers, so that the golf grip being held by the golfer can prevent the unwanted movement between the golfer's hand and the golf club, so as to prevent the golf club slipping out the golfer's hands.

Due to the importance of gripping the golf grip of the golf club, there are still lots of different designs of the golf grip, such as different patents to increase the frictions, or other physical ways, i.e. adding cottons on the golf grip. Some of the golf grips are divided into several portions having different textures from the neighboring portions, wherein each of the portions are coaxially provided along the golf shaft. In order words, each of the portions are continually formed a plurality of rings, such that the arrangement can further increase the frictions between the golfer's hands and the golf grip surface.

Stably gripping the golf club can help accurately align the golf ball and the club head. The correctly gripping of the golf club by holding the golf grip can significantly help the golfer to perfectly swing the golf club, so as to control the golf ball moving direction and distance as the golfer desired. Thus, accurately swinging the golf club is one of the main concerns of golf performances.

Regardless the overall constructions of the golf club, another common problem that often encountered is the misalignment when the club head hitting the golf ball. Any slightly movements could cause different result of the moving direction and speed of the golf ball. The current golf grip can only prevent the unwanted movement, but not the unwanted twisted rotation while the golfer is swinging.

Even if the golfer is holing the grip in a proper orientation, the slightly twisted movement is possibly occurred while swinging the golf club, so as to inaccurately hit the golf ball. Therefore, the inaccurate hitting angle between the hitting contact of the club head and the golf ball will substantially decrease the golf performances.

### SUMMARY OF THE PRESENT INVENTION

A main object of the present invention is to provide a golf grip, wherein the golf grip comprises a holding control arrangement having at least two different gripping frictions along the longitudinal direction to provide different gripping properties.

Another object of the present invention is to provide a golf grip, wherein a holding control arrangement provides an effective way for preventing the unwanted twisting force which is along a tangent direction of the longitudinal golf shaft.

Another object of the present invention is to provide a golf grip, wherein a plurality of first and second controlling surfaces are longitudinally provided along the longitudinal axis direction of the golf shaft in an alternating manner.

Another object of the present invention is to provide a golf grip, wherein the first and second controlling surfaces longitudinally provided on an outer circumferential surface of a grip member are alternating to each other.

Accordingly, in order to accomplish the above objects, the golf grip of the present invention comprises:

a tubular grip member, having an upper end and a lower end, adapted for coaxially encircling with the shaft along a longitudinal axis thereof;

a holding control arrangement provided on an outer circumferential surface of the grip member to define a plurality of first controlling surfaces extending at a longitudinal direction of the grip member from the upper end towards the lower thereof, and a plurality of second controlling surfaces alternating with the first controlling surfaces, wherein the first and second controlling surfaces have different gripping frictions to provide two different gripping properties of the grip member; and

an endpiece formed at the upper end of the grip member.

Accordingly, the present invention also provides a method of manufacturing the golf grip, comprises the steps of the following steps.

(a) Form a tubular grip member having an upper end and a lower end, for coaxially encircling with the shaft along a longitudinal axis thereof.

(b) Form a plurality of first and second controlling surfaces, extending at a longitudinal direction of the grip member from the upper end towards the lower end of the grip member, wherein the first controlling surfaces are alternating with the second controlling surfaces on an outer circumferential surface of the grip member.

(c) Vulcanize the grip member in a heat mold to integrally form the first and second controlling surfaces on the outer circumferential surface of the grip member to have different gripping frictions so as to provide two different gripping properties of the grip member.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a golf grip with holding control arrangement according to a preferred embodiment of the present invention.

FIG. 2 is a sectional view of the golf grip according to the preferred embodiment of the present invention.

FIG. 3 illustrates a method of manufacturing a golf grip with holding control arrangement according to the preferred embodiment of the present invention.

FIG. 3A is a sectional view of a heat mold of the method of manufacturing of the golf grip with holding control arrangement according to the preferred embodiment of the present invention.

FIG. 3B is a sectional view of an alternative heat mold of the method of manufacturing of the golf grip with holding control arrangement according to the preferred embodiment of the present invention.

FIG. 4 is a perspective view of the holding control arrangement according to the preferred embodiment of the present invention.

FIG. 5 is a schematic perspective view of the golf grip being held by a golfer according to the preferred embodiment of the present invention.

FIG. 6 is a perspective view of an alternative golf grip with holding control arrangement according to the preferred embodiment of the present invention.

### DETAILED DESCRIPTION OF THE PREFERRED EMBODIMENT

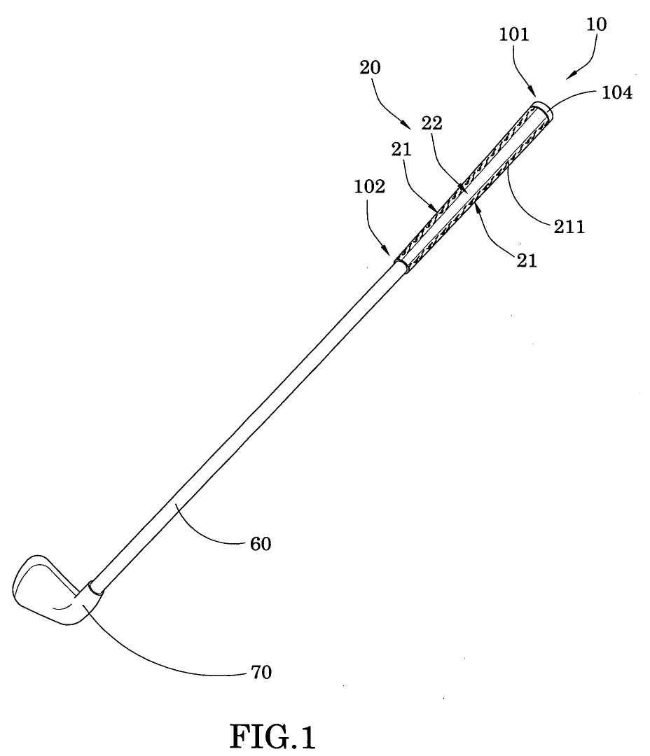

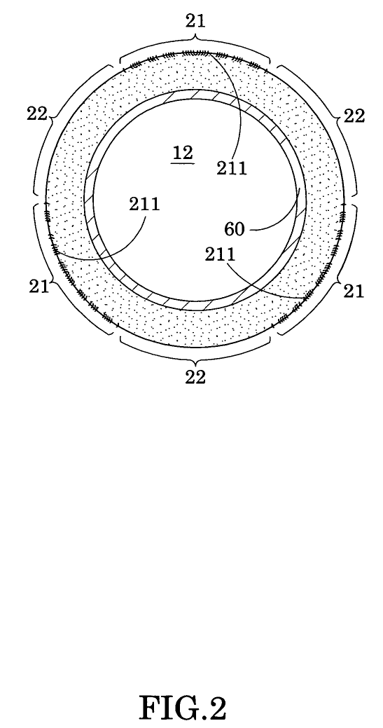

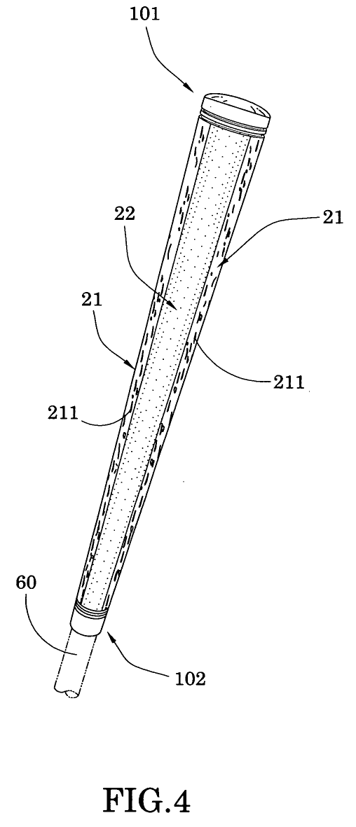

Referring to FIGS. 1, 2 and 4 of the drawings, a golf grip according to a preferred embodiment of the present invention is illustrated, wherein the golf grip comprises a tubular grip member 10 and a holding control arrangement 20 provided on a circumferential surface of the tubular grip member 10.

The golf grip is adapted for incorporating with a golf club including a shaft 60 and a club head 70 attached to a lower end of the shaft 60, wherein the tubular grip member 10 of the golf grip is provided at the other upper end of the shaft 60. The grip member 10 has a receiving cavity 12 for receiving the shaft 60 of the golf club, wherein the grip member 10 is coaxially enclosing the upper end of the shaft 60 within the receiving cavity 12 of the grip member 10, so that the grip member 10 is longitudinally encircling with the shaft 60 along a longitudinal axis of the shaft 60.

The holding control arrangement 20 is provided at the circumferential surface of the grip member 10, so that the grip member 10 is adapted at a position being held by a golfer griping the holding control arrangement 20. The holding control arrangement 20 is provided at the circumferential surface to define a first controlling surface 21 and a second controlling surface 22 longitudinally extending in an alternating manner.

The first and second controlling surfaces 21, 22 have different textures having different frictional coefficients, wherein the first controlling surface 21 has a higher frictional coefficient than the second controlling surface 22. In other words, the first controlling surface 21 has a coarse face rougher than the second controlling surface 22. In order to give two different griping properties of the holding control arrangement 20 on the grip member 10, preferably a textile fabric 211 is provided on the first controlling surface 21 of the holding control arrangement 20, so that the first controlling surface 21 has a higher frictional coefficient than the second controlling surface 22.

Accordingly, the textile fabric 211 is longitudinally overlapping on the outer circumferential surface of the grip member 10 to form the first controlling surface 21 of the holding control arrangement 20. The textile fabric 211 formed the first controlling surface 21 is longitudinally extended from an upper end 101 toward a lower end 102 of the grip member 10. An endpiece 104 of the grip member 10 further integrally formed at the upper end 101 of the grip member 10 to form the receiving cavity 12, so as to completely enclosing the upper end of the shaft 60 therewithin.

The textile fabric 211 is embodied as cotton yarn, wherein the cotton yarn of the textile fabric 211 is integrally formed on the first controlling surface 21 on the outer circumferential surface of the grip member 10. Thus, the cotton yarn of textile fabric 211, preferably, is vulcanized on the outer circumferential surface of the grip member 10 to form each of the first controlling surfaces 21, in such a manner that the first controlling surface 21 renders a less elasticity than the second controlling surface 22.

It is worth pointing out the lower elasticity of the first controlling surfaces 21 can decrease an unwanted movement due to the elastic property of the material of the grip member 10. In order words, the cotton yarn of the textile fabric 211 vulcanized on the first controlling surface 21 is capable of enhancing a griping ability of grip member 10, while the golfer is holding the golf grip to swing the golf club.

As mentioned above, the first controlling surface 21 is longitudinally extended from the upper end 101 to the lower end 102 of the grip member, wherein the second controlling surface 22 is alternating with the first controlling surface 21, such that the two different frictional coefficients of the gripping properties longitudinally alternating with each other is capable of preventing an unwanted movement due to a twisting force along a tangent direction of the outer circumferential surface of the tubular shape of grip member 10, so as to reduce the occurrence of unwanted twisting movement while the golfer is swinging.

As shown in FIGS. 1, 2 and 5, the first controlling surfaces 21 of the holding control arrangement 20 of the golf grip are embodied as a plurality of longitudinal tapered shape extended from the upper end 101 and the lower end 102 of the grip member 10, and alternating with each other, wherein the width of each of the first controlling surfaces 21 is gradually narrowed down from the upper end 101 toward the lower end 102 of the grip member 10.

In order words, the grip member 10 has a tubular shape having a circumferential size gradually decreasing from the upper end 101 to the lower end 102, so that the first and second controlling surfaces 21, 22 having longitudinal tapered shape can be fittingly cover the outer circumferential surface of the grip member 10.

In this embodiment of the golf grip, each of the first controlling surfaces 21 overlapped with the cotton yarn of fabric textile 211 is longitudinally adjacent to two of the second controlling surfaces 22 side by side. Therefore, the first and second controlling surfaces 21, 22 are alternately and intervally provided on the outer circumferential surface of the grip member 10 to form the holding control arrangement 20 thereon.

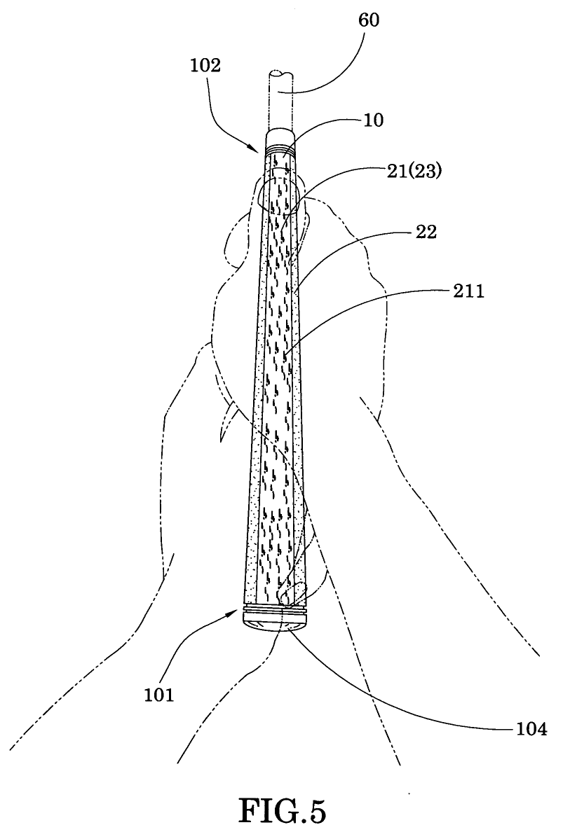

Accordingly, the longitudinal shape of the first and second controlling surface 21, 22 alternately and/or intervally arranged to each other provide a resistant force along a tangent direction of the tubular grip member 10, so as to prevent the unwanted twisting movement occurred while the golfer's holding the golf grip member 10 to swing the golf club, as shown in FIG. 5.

In order words, the first and second controlling surface 21, 22 extended from the upper end 101 toward the lower end 102 of the grip member 10 longitudinally distributes different textures of frictional coefficient surfaces, such that the longitudinal arrangement between two different frictional coefficients of the first and second controlling surfaces 21, 22 substantially provide a transverse resistant force to prevent the unwanted twisting force between the contact of the golfer's hands and the outer circumferential surface of the grip member 10.

It is worth mentioning that a length of each of the longitudinal first and/or second controlling surface 21, 22 extended from the upper end 101 toward the lower end 102 is at least long enough for being held by one hand of the golfer, so that the holding control arrangement 20 is capable of providing the transverse resistant force while the golfer is swinging the golf club to prevent the unwanted twisting movement, so as to further prevent the golf club slipping out the golfer's hand by the holding control arrangement 20 and the material of the grip member 10 itself. In order words, the first and/or second controlling surfaces 21, 22 may be extended entirely from the upper end 101 to the lower end 102 of the grip member 10, or longitudinally extended partially only a portion of the grip member 10, wherein the portion of the grip member 10 is long enough for being held by the golfer's hand.

Another advantage of the longitudinal first or second controlling surfaces 21, 22 of the holding control arrangement 20 is being used as an alignment tool for accurately aligning the club head 70 to the hitting surface of the golf ball. Accordingly, one of the first or second controlling longitudinal surfaces 21, 22, preferably the first controlling surface 21, is marked to form an alignment surface 23 thereon, as shown in FIG. 5. The alignment surface 23 is longitudinally extended along the grip member 10 at a position that the alignment surface 23 is arranged for alignedly squaring with a face of the club head 70 to ensure a face position of the club head 70.

In order words, the alignment surface 23 is provided for the golfer alignedly holding the grip member 10 preferably by the means of aligning one of the golfer's fingers with the marked alignment surface 23, so as to accurately hit the golf ball in a preferred hitting angle between the face of golf club and the ball.

It is appreciated that the alignment surface 23 provided on one of the first or second controlling surfaces 21, 22 offers the beginning golf sport players a reference of how to correctly align the golf head with the golf ball via the golf shaft and the grip member 10. Also, another example for relatively more professional golfers, the alignment surface 23 can be used as a curving reference when the golfer wants to curve the golf ball around a bunch of trees and onto the front fringe, such that the golfer is able to rotate a predetermined angle of the grip member 10 away from the alignment surface 23 depending on different situations.

Accordingly, when the golfer holds the grip member 10 to align with the alignment surface 23, the face of the club will be perpendicular to the vector direction of the swing. Once the golfer holds the grip member 10 to slightly offset with the alignment surface 23 to turn the club face in or out so as to leave the club face open or close, the golfer will induce a spin in that direction which will cause a hook or slice of the golf ball.

The first and/or second controlling surface 21, 22 may further be colored, so that the first and second controlling surfaces 21, 22 have two different colors. The different colors provide a pattern that the golfer is able to distinguish one controlling surface from the other, so as to decorate the golf grip for personalization, alignment, or other purposes. Also, each of the first or second controlling surfaces 21, 22 may be painted to different colors for decoration or indicia applications.

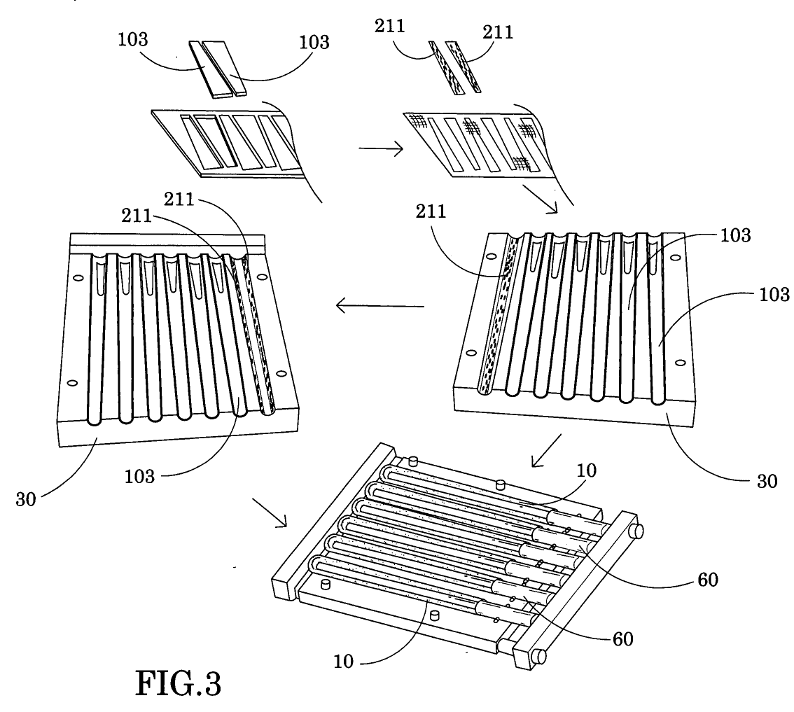

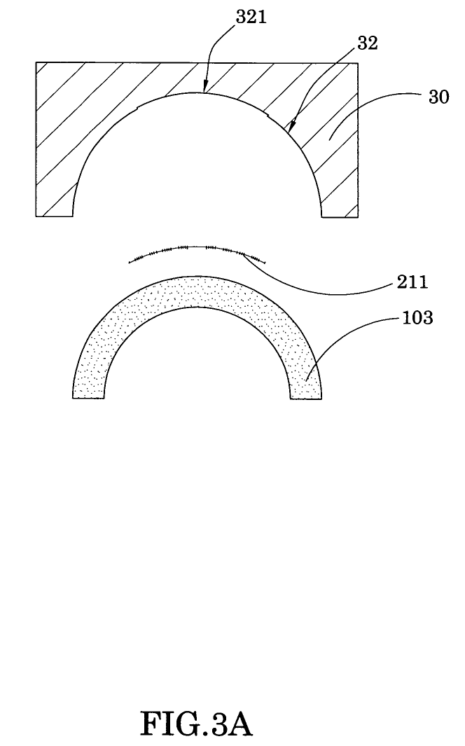

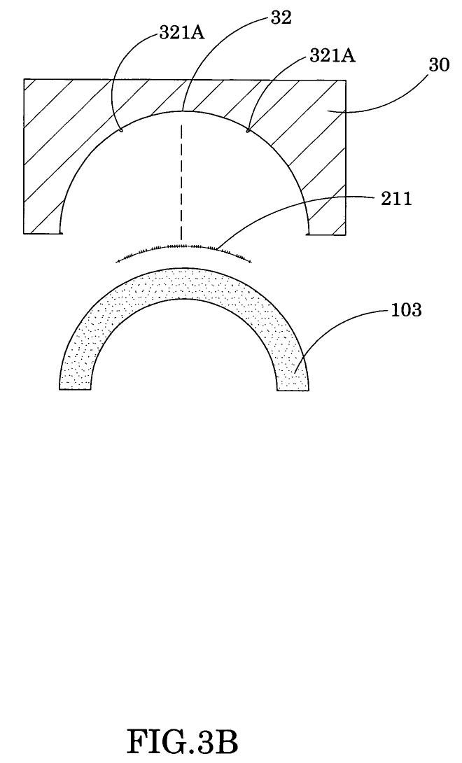

Referring to FIG. 3 of the drawings, in order to better understand the structure of the golf grip of present invention, a method of manufacturing the golf grip according to the preferred embodiment of the present invention is illustrated, wherein the method comprises the following steps.

(1) Form the tubular grip member 10 having an upper end 101 and a lower end 102, for coaxially encircling with the shaft 60 along a longitudinal axis thereof.

(2) Form the first and second controlling surfaces 21, 22 extending at a longitudinal direction of the grip member 10 from the upper end 101 towards the lower end 102 of the grip member 10, wherein the first controlling surfaces 21 are alternating with the second controlling surfaces 22 on the outer circumferential surface of the grip member 10.

(3) Vulcanize the grip member 10 in a heat mold 30 to integrally form the first and second controlling surfaces 21, 22 on the outer circumferential surface of the grip member 10 to have different gripping frictions so as to provide two different gripping properties of the grip member 10.

In the step (1), the method of the present invention further comprises a step (1.1) of forming a plurality of longitudinally tapered pieces 103 for forming the tubular grip member 10, wherein the two tapered pieces 103 are coupled with each other longitudinally side-by-side to form the tubular grip member 10, so that the grip member 10 is configured to has the tapered shape. The grip member 10, therefore, is formed a longitudinally tubular shape having an outer circumferential surface and defining a receiving cavity 12 therewithin for encircling the shaft 60 of the golf club.

Therefore, each of the first and second controlling surfaces 21, 22 has a tapered shape that a width of each of the first and second controlling surfaces 21, 22 is gradually reducing from the upper end 101 of the grip member 10 towards the lower end 102 thereof.

As described above, the step of (2) further comprises a step of (2.1) longitudinally overlapping a textile fabric 211 on the outer circumferential surface of the grip member 10 to form each of the first controlling surfaces 21. The textile fabric 211 is embodied as cotton yarn, having a relatively higher frictional coefficient, so as to provide the different griping properties for the golfer. The textile fabric 211 is integrally coated on the respective first controlling surface 21 after a heat-treatment, such that each of the first controlling surfaces 11 on the grip member 10 has a frictional coefficient higher than a frictional coefficient of each of the second controlling surfaces on the grip member 10.

In order to accomplish the heat-treatment to integrally form the textile fabric 211 on the first controlling surface 21 on the outer circumferential surface of the grip member 10, the heat mold 30 from the step (3) is applied to integrally coupling the two longitudinal tapered shape pieces 103 from the step (1.1) to form the tubular shape grip member 10 and to integrally form the textile fabric 211, embodied as cotton yarn, on the first controlling surface 21.

The heat mold 30 has a retention cavity 31 having a retention surface 32 thereon, wherein the retention surface 32 has a shape and area geographically matching the tapered piece 103 for holding and forming a predetermined longitudinal semi-circular shape of the tapered piece 103, in such a manner that two halves of the heat mold 30 are covering with each other to form the longitudinal tubular shape of grip member 10 corresponding to a predetermined shape and size of the golf grip, as shown in FIG. 3A.

In other words, the shaft 60 of the golf club are provided within the two halve of the heat mold 30 at a central position, wherein two halve of the heat mold 30 are longitudinally aligned with each other side-by-side and along the longitudinal axis of the shaft 60, such that the two tapered pieces 103 being held within each of the retention cavity 31 of the heat mold 30 are sandwiched between the shaft 60 and the retention surface 32 of the heat mold 30.

As shown in FIG. 3A, the retention surface 32 of the retention cavity 31 of the heat mold 30 further has a plurality of guiding members 321 inwardly indented into the retention surface 32 to form a plurality of guiding indentions, wherein the guiding members 321 are longitudinally, spacedly and evenly provided at the retention surface 32 of the retention cavity 31 of the heat mold 30, wherein the guiding member 321 has a predetermined shape and size corresponding to the first controlling surface 21. Therefore, in the step of (2.1), the textile fabric 211 is able to be received in the guiding member 321 for overlapping the textile fabric 211 on the first controlling surface 21 and being vulcanized to integrally formed the textile fabric 211 with the first controlling surface 21 on the outer circumferential surface of the grip member 10 in the step (3).

Alternatively, the guiding members 321A may be protruded outwardly from the retention surface 32 of the heat mold 30, wherein the textile fabric 211 is capable of being received within a space between the two guiding members 321A corresponding to a predetermined shape and size of the first controlling surface 21 of the holding control arrangement 20, so that the textile fabric 211 being received between the space of the two neighboring guiding members 321A is capable of overlapping with the first controlling surface 21, so as to integrally formed with the tapered piece 103 after heat treatment as shown in FIG. 3B.

It is worth mentioning that the tapered shape of the grip member 10 to gradually increase its outer diameter from the lower end 102 to the upper end 101 of the grip member 10 is enable to increase the ergonomic effect for being held by the hands of the golfer. Thus, the thickness of the upper end 101 is thicker than the lower end 102 of the grip member 10 of the golf grip.

In the step (3), after the two halves of the heat mold 30 are overlapped side-by-side to each other to form a tubular shape within the two retention cavities 31 of each of the heat mold, and sandwiching the tapered pieces 103 between the shaft 60 of the golf club and the heat molds 30, a heat source is applied for the heat treatment. The heat treatment is provided for integrally coupling each of the two tapered pieces 103, and to vulcanize the grip member 10 to integrally form the textile fabric 211 with the outer circumferential surface of the grip member 10, so as to form the first controlling surface 21.

A step of coloring the first and second controlling surfaces 21, 22 are further provided for distinguishing the first and second controlling surfaces 21, 22, so that the first and second controlling surfaces 21, 22 have two different colors. The different colors provide a pattern that the golfer is able to distinguish one controlling surface from the other, so as to decorate the golf grip for personalization, alignment, or other purposes. Also, each of the first or second controlling surfaces 21, 22 may be painted to different colors for decoration or indicia applications.

One of the first or second controlling surfaces 21, 22 is further being marked as the alignment surface 23 of the grip member in the heat mold 30, wherein the alignment surface 23 is capable of being used as the indicia for aligning the club head 70 face with the golf ball, so as to be sued as a reference of the contacting angle between the golf club head 70 and the ball when the golfer is swinging.

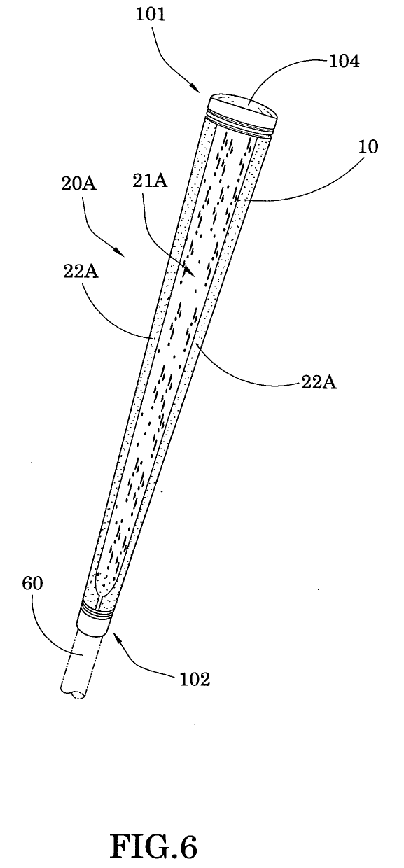

Referring to FIG. 6 of the drawings, an alternative holding control arrangement 20A of the preferred embodiment of the present invention is illustrated, wherein the grip member is manufactured by the method of producing the golf grip as above described, beside the different shapes of the first controlling surface 21 A and the second controlling surface 22A from the above first and second controlling surfaces 21, 22 of the preferred embodiment of the present invention, so as to have different shapes of the guiding members 321 of the heat mold 30 of the preferred embodiment.

The first and second controlling surfaces 21A, 22A of the holding control arrangement 20A have a curved shape and are longitudinally extended from the upper end 101 toward the lower end 102 of the grip member 10, wherein the first and second controlling surfaces 21A, 22A are alternating to each other to form the holding control arrangement 20A on the outer circumferential surface of the grip member 10.

Accordingly, in order to form the different shapes of the controlling surfaces, the heat mold 30 applied for heat treatment to form the predetermined shape of the grip member 10 and the shape of the first and second controlling surfaces 21A, 22A, a guiding member 321 of the retention surface 32 of the heat mold 30 has a size and shape inwardly or outwardly protruded from the retention surface 32 for receiving the textile fabric 211, in such a manner that the textile fabric 211 is capable of overlapping with the outer circumferential surface of the grip member 10 to define the first controlling surface 21A, so as to form the second controlling surface 22. The curved shape of the first and second controlling surface 21A, 22A longitudinally extended on the outer circumferential surface of the grip member 10 is at least long enough for being held by the hands of the golfer, so as to prevent the unwanted twisted force while the golfer is swinging the golf club.

It is worth mentioning that no matter the tapered, straight, or curved shape of the controlling surface, the longitudinally extended controlling surface from the upper end 101 toward the lower end 102 of the grip member 10 is capable of effectively preventing the happening of unwanted movement, especially the unwanted twisting movement due to the tangent force between the grip member 10 and the hands of the golfer while the golf club is being swung. With the holding control arrangement 20, 20A of the present invention, the golf grip is able to enhance the performance of playing golf.

The first and second controlling surfaces 21, 21A, 22, 22A can be interchanged to each other to form other combinations or shapes alternatively and longitudinally provided on the outer circumferential surface of the grip member 10 to prevent the unwanted twisting force happed while swinging the golf club.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A golf grip for a golf club including a shaft and a club head attached to a lower end of the shaft, wherein said golf club grip comprises:
a tubular grip member, having an upper end and a lower end, adapted for coaxially encircling with said shaft along a longitudinal axis thereof,
a holding control arrangement provided on an outer circumferential surface of said grip member to define a plurality of first controlling surfaces extending at a longitudinal direction of said grip member from said upper end towards said lower thereof, and a plurality of second controlling surfaces alternating with said first controlling surfaces, wherein said first and second controlling surfaces have different gripping frictions to provide two different gripping properties of said grip member; and
an endpiece formed at said upper end of said grip member.

2. The golf grip, as recited in claim 1, wherein each of said first controlling surfaces on said grip member has a frictional coefficient higher than a frictional coefficient of each of said second controlling surfaces on said grip member.

3. The golf grip, as recited in claim 1, wherein said holding control arrangement comprises a textile fabric longitudinally overlapping on said outer circumferential surface of said grip member to form said first controlling surfaces.

4. The golf grip, as recited in claim 2, wherein said holding control arrangement comprises a textile fabric longitudinally overlapping on said outer circumferential surface of said grip member to form each of said first controlling surfaces.

5. The golf grip, as recited in claim 3, wherein said textile fabric is cotton yarn vulcanized on said outer circumferential surface of said grip member to form each of said first controlling surfaces, such that said first controlling surfaces render a less elasticity than said second controlling surface for enhancing a gripping ability of said grip member.

6. The golf grip, as recited in claim 4, wherein said textile fabric is cotton yarn vulcanized on said outer circumferential surface of said grip member to form each of said first controlling surfaces, such that said first controlling surfaces render a less elasticity than said second controlling surface for enhancing a gripping ability of said grip member.

7. The golf grip, as recited in claim 1, wherein one of said first controlling surfaces, as an alignment surface, is longitudinally extended along said grip member at a position that said alignment surface is arranged for alignedly squaring with a face of said club head to ensure a face position of said club head.

8. The golf grip, as recited in claim 4, wherein one of said first controlling surfaces, as an alignment surface, is longitudinally extended along said grip member at a position that said alignment surface is arranged for alignedly squaring with a face of said club head to ensure a face position of said club head.

9. The golf grip, as recited in claim 6, wherein one of said first controlling surfaces, as an alignment surface, is longitudinally extended along said grip member at a position that said alignment surface is arranged for alignedly squaring with a face of said club head to ensure a face position of said club head.

10. The golf grip, as recited 1, wherein each of said first and second controlling surfaces has a tapered shape that a width of each of said first and second controlling surfaces is gradually reducing from said upper end of said grip member towards said lower end thereof.

11. The golf grip, as recited 6, wherein each of said first and second controlling surfaces has a tapered shape that a width of each of said first and second controlling surfaces is gradually reducing from said upper end of said grip member towards said lower end thereof.

12. The golf grip, as recited 9, wherein each of said first and second controlling surfaces has a tapered shape that a width of each of said first and second controlling surfaces is gradually reducing from said upper end of said grip member towards said lower end thereof.

13. The golf grip, as recited in claim 1, wherein said first and second controlling surfaces have different colors.

14. The golf grip, as recited in claim 6, wherein said first and second controlling surfaces have different colors.

15. The golf grip, as recited in claim 12, wherein said first and second controlling surfaces have different colors.

16. A method of manufacturing a golf grip for a golf club including a shaft and a club head attached to a lower end of the shaft, comprising the steps of:
(a) forming a tubular grip member, having an upper end and a lower end, for coaxially encircling with said shaft along a longitudinal axis thereof;
(b) forming a plurality of first and second controlling surfaces extending at a longitudinal direction of said grip member from said upper end towards said lower thereof, wherein said first controlling surfaces are alternating with said second controlling surfaces on said grip member; and
(c) vulcanizing said grip member in a heat mold to integrally form first and second controlling surfaces on said grip member to have different gripping frictions so as to provide two different gripping properties of said grip member.

17. The method, as recited in claim 16, wherein the step (b) further comprises the step of longitudinally overlapping a textile fabric on said outer circumferential surface of said grip member to form each of said first controlling surfaces, wherein said textile fabric is integrally coated on said respective first controlling surface after heat-treatment, such that each of said first controlling surfaces on said grip member has a frictional coefficient higher than a frictional coefficient of each of said second controlling surfaces on said grip member.

18. The method as recited in claim 17 wherein, during the step (c), said textile fabric is cotton yarn and is vulcanized to integrate with said grip member to form said first controlling surfaces, wherein portions of said textile fabric are evenly and spacedly exposed outside said grip member after vulcanization so as to produce a coarse exterior surface as said first controlling surface of said grip member.

19. The method as recited in claim 16 wherein, in the step (b), one of said first controlling surfaces, as an alignment surface, is designated to longitudinally extend along said grip member at a position that said alignment surface is arranged for alignedly squaring with a face of said club head to ensure a face position of said club head.

20. The method as recited in claim 17 wherein, in the step (b), one of said first controlling surfaces, as an alignment surface, is designated to longitudinally extend along said grip member at a position that said alignment surface is arranged for alignedly squaring with a face of said club head to ensure a face position of said club head.

21. The method as recited in claim 18 wherein, in the step (b), one of said first controlling surfaces, as an alignment surface, is designated to longitudinally extend along said grip member at a position that said alignment surface is arranged for alignedly squaring with a face of said club head to ensure a face position of said club head.

22. The method as recited in claim 16 wherein, in the step (a), said grip member is configured to have tapered shape, wherein each of said first and second controlling surfaces has a tapered shape that a width of each of said first and second controlling surfaces is gradually reducing from said upper end of said grip member towards said lower end thereof.

23. The method as recited in claim 18 wherein, in the step (a), said grip member is configured to have tapered shape, wherein each of said first and second controlling surfaces has a tapered shape that a width of each of said first and second controlling surfaces is gradually reducing from said upper end of said grip member towards said lower end thereof.

24. The method as recited in claim 21 wherein, in the step (a), said grip member is configured to have tapered shape, wherein each of said first and second controlling surfaces has a tapered shape that a width of each of said first and second controlling surfaces is gradually reducing from said upper end of said grip member towards said lower end thereof.

25. The method, as recited in claim 16, wherein the step (a) further comprises a step of coloring said grip member at said first and second controlling surfaces, such that said first and second controlling surfaces have different colors.

26. The method, as recited in claim 18, wherein the step (a) further comprises a step of coloring said grip member at said first and second controlling surfaces, such that said first and second controlling surfaces have different colors.

27. The method, as recited in claim 24, wherein the step (a) further comprises a step of coloring said grip member at said first and second controlling surfaces, such that said first and second controlling surfaces have different colors.
